(19) United States
(12) Patent Application Publication
(10) Pub. No.: US 2021/0162922 A1
(43) Pub. Date: Jun. 3, 2021

(54) VEHICLE IMAGING SYSTEM

(71) Applicant: Ficosa North America Corporation, Madison Heights, MI (US)

(72) Inventors: Ricardo Gonzalez CAMARERO, Clawson, MI (US); Norbert Anthony BIKOS, Oakland Township, MI (US); Troy L. KIRCHHOFER, Berne, IN (US); Damon Paul BLAICHER, Madison Heights, MI (US)

(21) Appl. No.: 16/700,622

(22) Filed: Dec. 2, 2019

(51) Int. Cl. B60R 1/00; B60R 11/04

(52) U.S. Cl. CPC B60R 1/00; B60R 11/04; B60R 2300/303; B60R 2300/8046; B60R 2300/105; B60R 2300/8066

(57) ABSTRACT

A vehicle imaging system may include a first camera assembly configured to capture at least one first image of a vehicle first side area, a second camera assembly configured to capture at least one rear image of a vehicle rear area. The system may further include a controller in communication with the first camera assembly and second camera assembly and configured to receive the first image and the rear image and combine at least a portion of the first image and at least a portion of the rear image to generate a first side-rear image of the vehicle. The system may include a first display arranged adjacent a driver viewing area and configured to display the first side-rear image.

### TECHNICAL FIELD

Disclosed herein are vehicle imaging systems.

### BACKGROUND

Motor vehicles include various mirrors and cameras to provide imaging to vehicle occupants. Often times these images are for a rear or side view of the vehicle, so as to allow a driver to view these angles, while keeping his or her head in a forward position.

### SUMMARY

A vehicle imaging system may include a first camera assembly configured to capture at least one first image of a vehicle first side area and a second camera assembly configured to capture at least one rear image of a vehicle rear area. The system may include a first controller associated with the first camera assembly and configured to receive the first image and the rear image, and combine at least a portion of the first image and at least a portion of the rear image to generate a first side-rear image of the vehicle. The system may also include a first display arranged adjacent a driver viewing area and configured to display the first side-rear image and a third camera assembly configured to capture at least one second image of a vehicle second side area, opposite the vehicle first side area. The system may include a second controller associated with the third camera assembly and configured to receive the second image and the rear image, and combine at least a portion of the second image and at least a portion of the rear image to generate a second side-rear image of the vehicle. The system may include a second display arranged adjacent a passenger viewing area and configured to display the second side-rear image.

A vehicle imaging system may include a first camera assembly configured to capture at least one first image of a vehicle first side area, a second camera assembly configured to capture at least one rear image of a vehicle rear area. The system may further include a controller in communication with the first camera assembly and second camera assembly and configured to receive the first image and the rear image and combine at least a portion of the first image and at least a portion of the rear image to generate a first side-rear image of the vehicle. The system may include a first display arranged adjacent a driver viewing area and configured to display the first side-rear image.

A vehicle imaging system may include a left camera assembly configured to capture at least one left image of a vehicle left side area; a rear camera array configured to capture at least one rear image of a vehicle rear area, controller in communication with the left camera assembly and rear camera array and configured to receive the left image and the rear image, combine at least a portion of the left image and at least a portion of the rear image to generate a left-rear image of the vehicle. The system may include a left display arranged adjacent a driver viewing area and configured to display the left-rear image, a right camera assembly configured to capture at least one right image of a vehicle right side area, the controller in communication with the right camera assembly and further configured to receive the right image and the rear image, and combine at least a portion of the right image and at least a portion of the rear image to generate a right-rear image of the vehicle; and a right display arranged adjacent a passenger viewing area and configured to display the right-rear image.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example aerial view of vehicle having an imaging system;

FIG. 2 illustrates a block diagram of the imaging system of FIG. 1;

FIG. 3 illustrates a perspective view of an interior vehicle cabin displaying an image rendered by the imaging system;

FIG. 4 illustrates another perspective view of the interior vehicle cabin;

FIG. 5 illustrates a view of a vehicle cabin various locations for the display;

FIG. 6 illustrates a block diagram of another embodiment of the imaging system of FIG. 1;

FIG. 7 illustrates an example aerial view of vehicle having another embodiment of the imaging system;

FIG. 8 illustrates an example of stitching images of the imaging system of FIG. 1;

FIG. 9 illustrates an example of stitching images of the imaging system of FIG. 7; and

FIG. 10 illustrates another example of stitching images of the imaging system of FIG. 7.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is an imaging system for a vehicle that includes a controller associated with one of at least two camera assemblies. The controller may be configured to stitch the images provided by the camera assemblies to provide for an image that meets or exceeds regulations for side and rear view images typically provided for by a side mirror on the vehicle. Although an example configuration, the system herein includes two side camera assemblies, each associated with a side specific controller and configured to receive an image from a rear camera to provide for the regulation approved images.

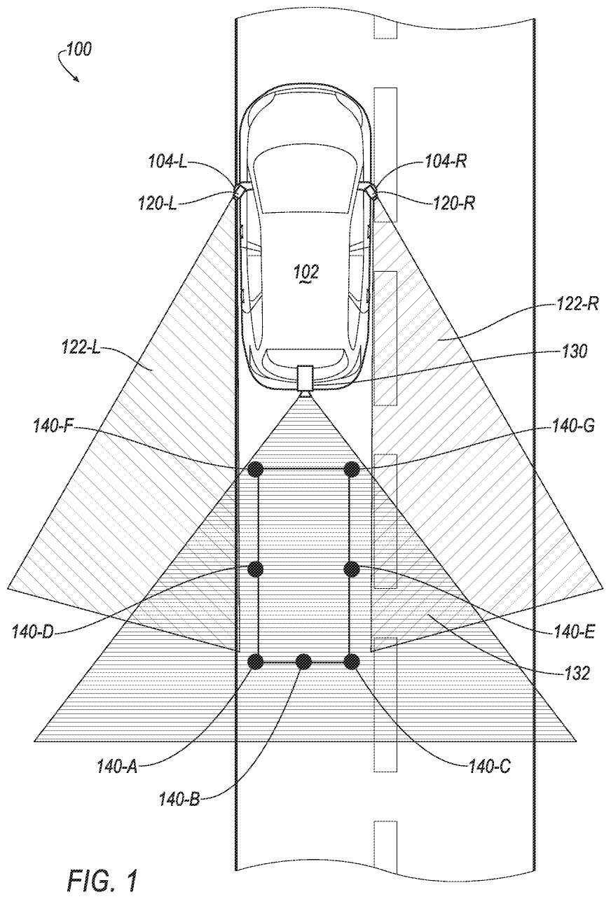

FIG. 1 illustrates an example aerial view of vehicle 102 having an imaging system 105. The vehicle 102 is illustrated as a sedan, but may be any motor passenger vehicle including but not limited to a truck, sport utility vehicle, cross-over, hatchback, station wagon, motorcycle, all-terrain vehicle (ATV), recreational vehicle (RV), bus, boat, plane or other mobile machine for transporting people or goods, etc.

The vehicle 102 may include at least one winglet 104, such as a side rearview viewing device (as shown in FIG. 1), or camera or radar or sensor array. The winglet 104 may also be a roof rack, door handle, or other protrusion of the vehicle or vehicle component. In the example shown in FIG. 1, the vehicle 102 includes a first, or left winglet 104-L and a second, or right winglet 104-R arranged opposite of the left winglet 104-L. More or less winglets 104 may be included in the system 100.

Each winglet 104 may house a camera assembly 120 (also referred to herein as camera 120 or side camera 120) configured to capture images of an image area. In the example of FIG. 1, the first winglet 104-L may include a first, or left camera assembly 120-L. The left camera assembly may capture images of a first, or left image area 122-L. The right winglet 104-R may include a second, or right camera assembly 120-R. The right camera assembly 120-R may capture images of a second, or right image area 122-R.

The camera assemblies 120 may be an optical tool configured to capture still images, a plurality of still images, or moving images. The camera may be digital and store such images in a digital system, or may include analog (RGB). The camera assembly 120 may include one or more lenses to focus light from an image area 122. Other attributes may be controlled and adjusted by the camera assembly 120 such as aperture, shutter, exposure, etc. Each camera assembly 120 may be configured to capture images of the respective image area 122. The image area may be dictated by the angle, size, location and field of the camera assembly 120. The vehicle 102 itself may also provide obstructions within the image area 122 and may therefore also affect the ability of the camera assembly 120 to capture certain field of views.

While the camera assemblies 120 are described throughout as being arranged on the winglet 104, the camera assembly 120 may also be mounted on other exterior areas of the vehicle 102. For example, the camera assembly 120 may be arranged on a door handle. The camera assembly 120 may be arranged on running boards, mud flaps, roof racks, bumpers, doors, roof, fenders, rockers, A-pillar, B-pillar, etc. The vehicle 102 may include more than two camera assemblies 120. In one example, a camera assembly 120 may be arranged on each exterior rearview mirror. A camera assembly 120 may also be arranged on each door handle.

The vehicle 102 may include a rear camera assembly 130 (also referred to herein as rear camera 130). The rear camera, similar to the camera assemblies 120, may be configured to capture images. The rear camera 130 may be configured to capture images of a rear image area 132. The rear image area 132 may include an area at the rear of the vehicle. The rear image area 132 may overlap, at least in some areas with the left image area 122-L and the right image area 122-R.

Various government entities and organizations may require certain field of view requirements to be met for vehicles. This may include field of views visible by the driver. Certain tests for the field of view requirements include ensuring that certain test objects are visible to the driver at certain locations relative to the vehicle 102. In the Example shown in FIG. 1, a plurality of test objects 140 are arranged behind the vehicle 102. The test objects are labeled individually as 140-A, 140-B, 140-C, 140-D, 140-E, 140-F, and 140-G. As shown in the figure, at least one of the image areas 122, 132 include each test object 140. That is, each test object 140 is capturable by at least one of the camera assemblies 120, 130.

Often times these field of views are provided by side and rear mirrors. However, these mirrors may often be required to extend out of the vehicle 102 in order to comply with field of view requirements. The use of winglets, such as winglets 104, may allow for lower profile, less obtrusive structures than the side mirrors. Further, the camera assemblies 120 included in the winglets 104 may be capable of certain field of views without taking up much space on or within the winglet. However, due to the angle and the size and shape of the vehicle, the field of view for the camera assemblies 120 may be limited.

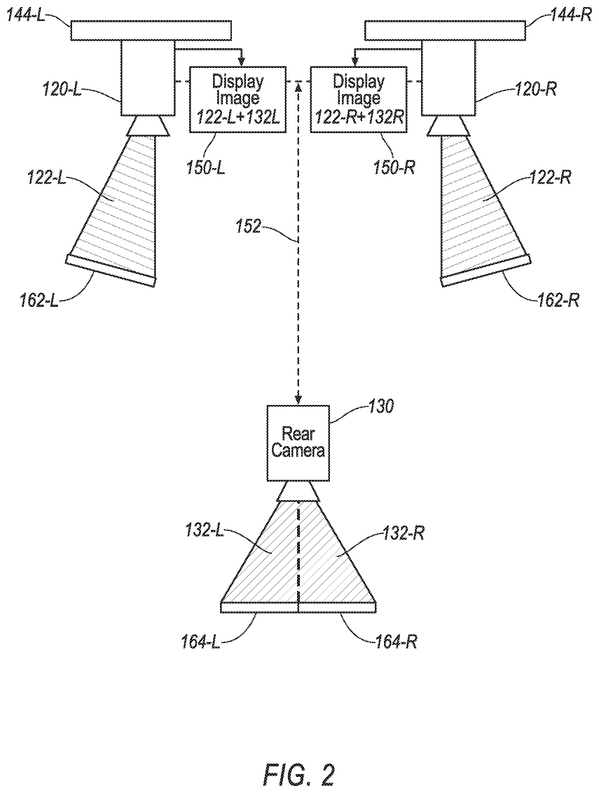

For example, all of the left test objects (i.e., 140-A, 140-D, 140-F) are not capturable within the left image area 122-L. Thus, the left camera assembly 120-L is not capable of providing images for all of the left test objects. Similarly, the right camera assembly 120-R is not capable of capturing images of all the right test objects. However, in combination with the rear image area, each of the test objects may be viewable. This is explained in more detail below with respect to FIG. 2.

FIG. 2 illustrates a block diagram of the imaging system of FIG. 1. Each of the camera assemblies 120 may be associated with a controller 144. The left camera assembly 120-L may be associated with a left controller 144-L and the right camera assembly 120-R may be associated with a right controller 144-R. The controllers 144 may include one or more processors configured to perform instructions, commands and other routines in support of the processes described herein. For instance, the controllers 144 may be configured to execute instructions to receive and render vehicle imaging provided by the camera assemblies 120, 130. Such instructions and other data may be maintained in a non-volatile manner using a variety of types of computer-readable storage mediums. The computer-readable mediums (also referred to as a processor-readable medium or storage) may include any non-transitory medium (e.g., a tangible medium) that participates in providing instructions or other data that may be read by the processor. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The controllers 144 may be in communication with a vehicle bus 152. The vehicle bus 152, also referred to herein as a vehicle network, may include one or more of a vehicle controller area network (CAN), an Ethernet network, and a media oriented system transfer (MOST), etc. The bus 152 may allow for communications with other vehicle systems, such as a vehicle modem, a global positioning system (GPS), and various vehicle electronic control units configured to incorporate with the computing platforms of the vehicle 102.

The controllers 144 may receive images from the rear camera 130 over the bus 152. Additionally or alternatively, the controllers 144 may communicate with the rear camera 130 wirelessly. The controllers 144 may receive images from the camera assemblies 120. While each controller is described as receiving and parsing images from their respectively associated camera assembly 120, each controller 144 may also receive images from the other one of the camera assemblies 120 as well.

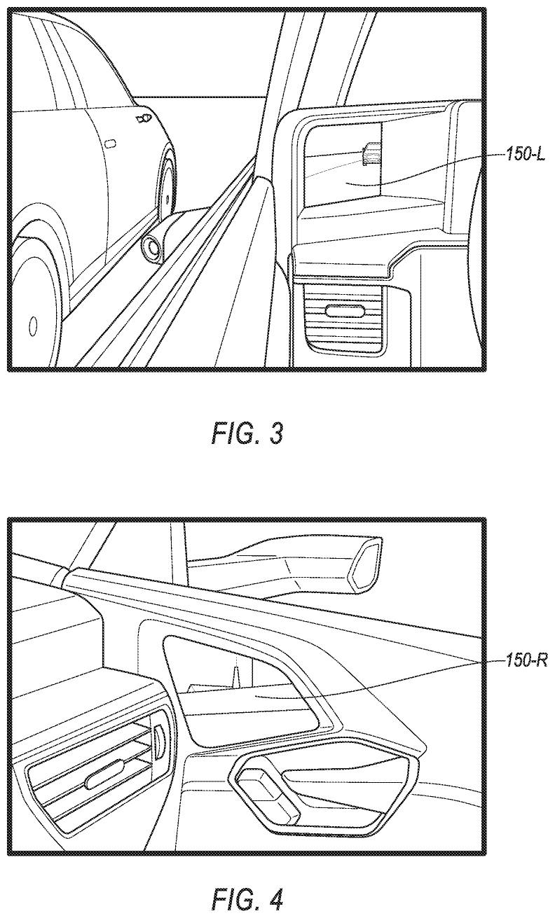

The vehicle 102 and the imaging system 100 may include at least one display 150. In the example of FIG. 2, the vehicle 102 includes a first, or left display 150-L and a second, or right display 150-R. Example displays and locations within the vehicle 102 are illustrated in FIGS. 3-5. In some cases, the display 150 may be a screen configured to provide digital images. The display 150 may include a touch screen further configured to receive user touch input via the controller 144, while in other cases the display 150 may be a display only, without touch input capabilities. The display 150 may be, for example but not limited to, a liquid crystal display (LCD), light emitting diode (LED), IPS-LCD (In-Plane Switching Liquid Crystal Display), OLED (Organic Light-Emitting Diode), AMOLED (Active-Matrix Organic Light-Emitting Diode), etc.

The display 150 may be a stand-alone unit arranged in addition to the vehicle components. Additionally or alternatively, the display 150 may be integrated into one or more interior components of the vehicle 102 such as the dashboard, center console, steering wheel, door frame, door panel, A-pillar, B-pillar, etc. The display 150 may also be a heads-up display (HUD) or projection on a surface of the vehicle interior.

The display 150 may be configured to display images of the area behind and beside the vehicle 102, similar to those a driver would expect to see from looking into a traditional side mirror. That is, the images may include areas not visible to the driver as the driver looks forward, but images of the side and rear of the vehicle 102 so as to make other vehicles, objects, etc., visible. The left display 150-L may display images typically provided by a left side mirror while the right display 150-R may display images typically provided by a right-side mirror.

In one example, the left controller 144-L may receive a first, or left image 162-L from the left camera 120-L. The first, or left image 162-L may include images from the left image area 122-L. The left controller 144-L may also receive a rear image 164 from the rear camera 130. The rear image 164 may be bifurcated into two halves, including a first, or left image 164-L and a second, or right image 164-R.

The left controller 144-L, upon receiving the first and second images, 162, 164, may generate a display image and transmit this display image to the left display 150-L. The display image may include an image of the left side and rear of the vehicle so as to make at least a portion of the test objects (not shown in FIG. 2) visible to the driver. For example, at least test objects 140-A, 140-B, 140-D and 140-F may be visible in the display image. The left controller 144-L may do this by stitching all or portions of the first and second images 162, 164 together. In one example, the left controller 144-L may stitch the left image 164-L with the right image 164-R to generate a complete rear-side view allowing for each of the test objects to be visible, and thus meeting or exceeding requirements for the view.

While each of the controllers 144 are illustrated and explained as being associated with their respective cameras 120, each controller 144 may be associated with the respective displays as well. For example, the left controller 144-L may be associated with either 120-L or 150-L and 144-R may be associated with either 120-R or 150-R. Further, each controller 144 may be in communication and associated with the other cameras 120, 130 and displays 150. For example, the left controller 144-L may be associated with either the right camera 120-R or right display 150-R and vice versa.

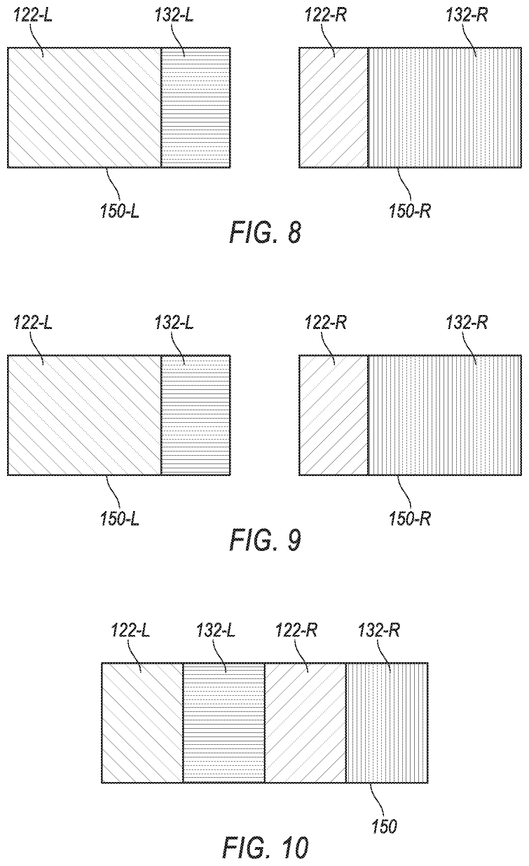

While the left image 164-L and the right image 164-R are illustrated as being generally halves of the rear image 164, the image may not be symmetrically or proportionally split. Depending on the turn angle of the vehicle 102, more or less of the rear image 164 may be necessary to achieve the desired image. This is described in more detail with respect to FIGS. 8-10.

The images 162, 164 may continually be provided via the display 150. That is, as the vehicle moves during operation, the images provided also update in real-time or near real-time. While the examples described herein generally relate to stitching the images in a side-by-side configuration, multiple image stitching configurations may be possible. For example, the images may overlap slightly, be illustrated as picture-in-picture format, etc.

Similarly, with respect to the right side of the vehicle 102, the right controller 144-R may receive a second, or right image 162-R from the right camera 120-R. The right image 162-R may include images from the right image area 122-R. The right controller 144-R may also receive the rear image 164 from the rear camera 130, including one or both of the left image 164-L and the right image 164-R.

The right controller 144-R, upon receiving the first and second images, 162, 164, may generate a display image and transmit this display image to the right display 150-R. The display image may include an image of the right side and rear of the vehicle so as to make at least a portion of the test objects visible to the driver. For example, at least test objects 140-B, 140-C, 140-E and 140-G may be visible. The right controller 144-R may do this by stitching all or portions of the first and second images 162, 164 together. In one example, the right controller 144-R may stitch the right image 164-R with the left image 164-L to generate a complete rear-side view allowing for each of the test objects to be visible, and thus meeting or exceeding requirements for the view.

Although not illustrated in FIG. 2, a separate controller may be associated with the rear camera assembly 130. This controller may communicate with one or both of the other controllers 144. In one example, this third controller may communicate with each of the controllers 144. In another example, the third controller may communicate with one of the controllers 144, and that controller 144 may then relay the necessary data or images to the other controller 144. For example, the third controller may communicate with the left controller 144-L. The left controller 144-L may then relay such communication between the third controller and the right controller 144-R forming a chain-type of communication between the camera assemblies 120, 130. Further, in another example, the rear camera 130 may communicate with the left controller 144-L, and the left controller 144-L may then communicate with the right controller 144-R for another example of a chain-type communication.

FIG. 3 illustrates a partial perspective view of an interior vehicle cabin displaying an image rendered by the imaging system 100. In this example, the display 150 is the left display 150-L arranged to the left of the steering wheel center line within the vehicle dash. The display 150, as explained above, may include an image in compliance with regulations to show the test objects 140.

FIG. 4 illustrates a partial perspective view of an interior vehicle cabin displaying an image rendered by the imaging system 100. In this example, the display 150 is the right display 150-R arranged in the right vehicle door, above a door handle. The display 150 similarly may include an image in compliance with regulations to show the test objects 140.

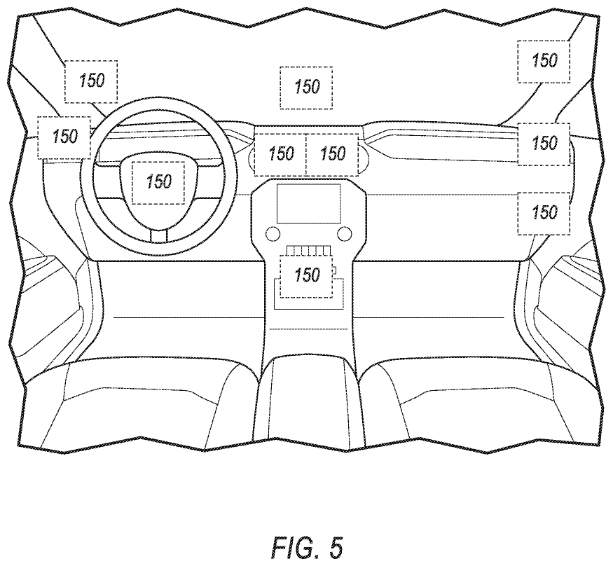

FIG. 5 illustrates a view of a vehicle cabin having multiple locations for the display 150. Any one of or all display locations may be included in the vehicle 102, including other locations not depicted in FIG. 5. For example, the display(s) 150 may be included within a steering wheel interface. The display 150 may be alone in the center console, on the doors, or in the dashboard. As explained above, the display 150 may also be a heads up display or projection anywhere within the vehicle. Additionally or alternatively, the display 150 may be arranged in other areas of the vehicle, such as the rear-view mirror location, windshield, door frame, door panel, A-pillar, or B-pillar.

In one example, the display 150 may include the left display 150-L arranged adjacent the driver near the steering wheel. The display 150 may include the right display 150-R arranged on the dashboard but on an opposite side as the left display 150-L. A third or rear display 150 may be arranged on the windshield or in the center of the dashboard for displaying a rear image.

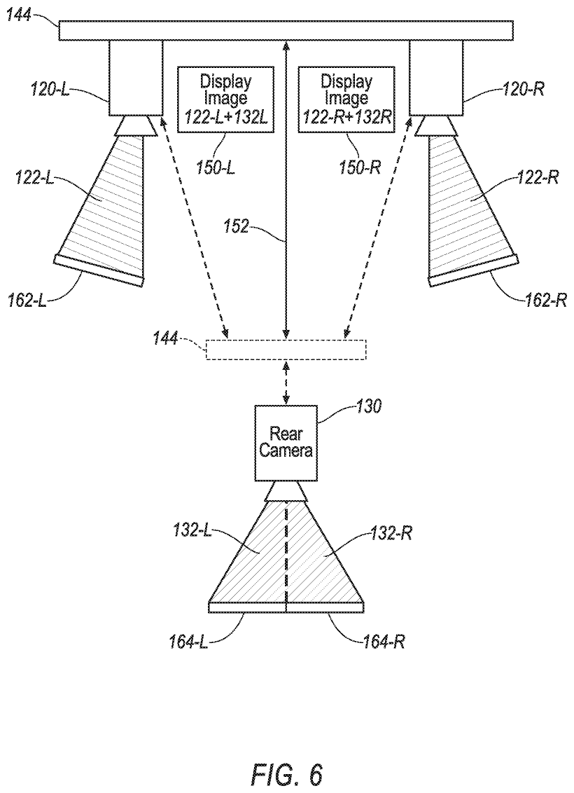

FIG. 6 illustrates a block diagram of another embodiment of the imaging system 100 of FIG. 1. FIG. 6 illustrates a block diagram similar to that of FIG. 2. However, unlike the example of FIG. 2 where each of the camera assemblies 120 may be associated with a controller 144, the camera assemblies 120 may each communicate with a single controller 144. In this example, the camera assemblies 120 may each connect to the controller 144 at a single wired connection, though wireless and other connections may be made between the components. This may aid in less maintenance and problem spotting due to less electrical connections being necessary. By using a single controller 144, lower cost may also be realized.

An alternative arrangement of the controller 144 is also illustrated in hashed line in FIG. 6. In this example, the rear camera assembly 130 may be in communication with the controller 144 and the controller functions as a splitter between the left and right camera assemblies 120.

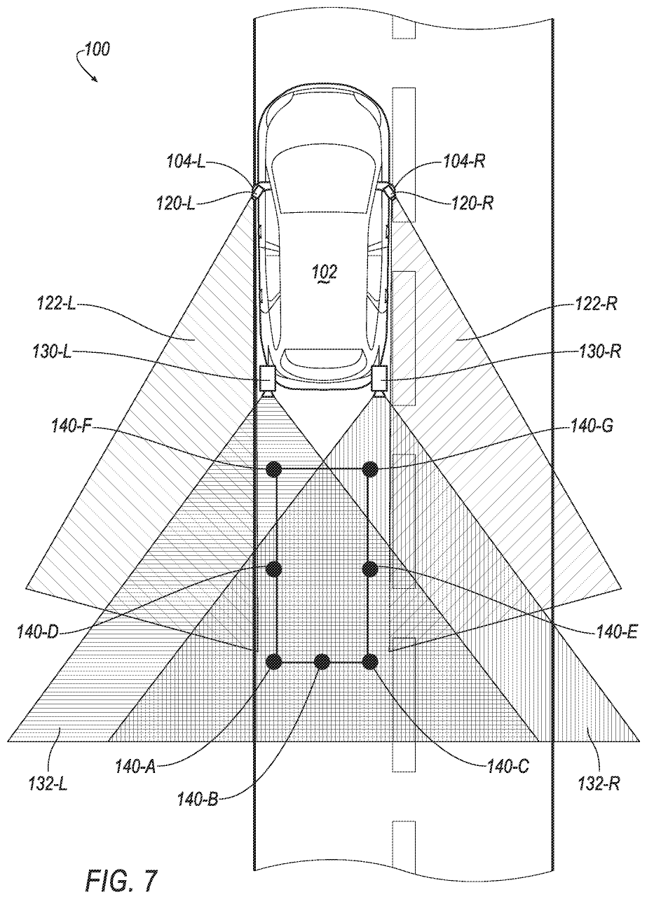

FIG. 7 illustrates an example aerial view of vehicle having another embodiment of the imaging system 100. FIG. 7 illustrates a system 100 similar to that of FIG. 1, but with an additional rear camera 130. In this example, the rear camera 130 includes at least two cameras 130, a left rear camera 130-L and a right rear camera 130-R. Accordingly, each of these two cameras 130 will be associated with a corresponding rear image area 132, such as a right rear image area 132-R and a left rear image area 132-L. These rear image areas 132, similar to the single rear image area 132 of FIG. 1, may overlap with the left and right image areas 122. The rear image areas 132 may overlap with one another as well. These cameras 130 may be used to stitch together an image to be displayed at the display 150.

FIGS. 8-10 illustrate example display configurations to show possible examples of how images may be combined between the various cameras 120, 130. FIG. 8 illustrates an example of stitching images of the imaging system of FIG. 1 for a side-rear image. The left display 150-L may include an image that is a combination of images from the left image area 122-L and the left rear image area 132-L. While the example in FIG. 8 illustrates a larger portion of the image being attributed to the left image area 122-L, any portion of each of the image areas 122-L, 132-L may be used. Similarly, the right display 150-R may include an image that is a combination of images from the right image area 122-R and the right rear image area 132-R.

FIG. 9 illustrates an example of stitching images of the imaging system of FIG. 7 where more than one rear camera may be used for generating the side rear images. The left display 150-L may display an image including captures from the left camera assembly 120-L and the left rear camera assembly 130-L. Conversely, the right display 150-R may display an image including captures from the right camera assembly 120-R and the right rear camera assembly 130-R. However, these are merely exemplary and each of the displays may display images compiled from more than two cameras, especially when the vehicle 102 is not traveling straight forward (e.g., when the vehicle is turning).

FIG. 10 illustrates another example of stitching images of the imaging system of FIG. 7 for generating a rear image. As explained above with respect to FIG. 5, the display 150 may be arranged at one of many locations throughout the vehicle 102 and images may be displayed other than those typically for purposes of replacing the side mirrors. In one example, the display 150 may include a rear-view of the vehicle 102. In the example where the rear camera 130 includes more than one rear camera, then the image may be stitched from all four cameras 120, 130.

Computing devices described herein generally include computer-executable instructions, where the instructions may be executable by one or more computing or hardware devices, such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions (e.g., from a memory, a computer-readable medium, etc.) and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle imaging system, comprising:
a first camera assembly configured to capture at least one first image of a vehicle first side area;
a second camera assembly configured to capture at least one rear image of a vehicle rear area;
a first controller associated with the first camera assembly and configured to
receive the first image and the rear image,
combine at least a portion of the first image and at least a portion of the rear image to generate a first side-rear image of the vehicle;
a first display arranged adjacent a driver viewing area and configured to display the first side-rear image;
a third camera assembly configured to capture at least one second image of a vehicle second side area, opposite the vehicle first side area;
a second controller associated with the third camera assembly and configured to
receive the second image and the rear image,
combine at least a portion of the second image and at least a portion of the rear image to generate a second side-rear image of the vehicle; and
a second display arranged adjacent a passenger viewing area and configured to display the second side-rear image.

2. The system of claim 1, further comprising a vehicle communication bus configured to transmit data between the first and second controllers.

3. The system of claim 1, wherein the first and third camera assemblies are arranged at opposite sides of the vehicle.

4. The system of claim 3, wherein the first and third camera assemblies are arranged on separate and distinct winglets of the vehicle.

5. The system of claim 1, wherein the second camera assembly is arranged at a rear of the vehicle.

6. The system of claim 1, wherein the first display is arranged to the left of the steering wheel center line.

7. The system of claim 6, wherein the second display is arranged to the right of the steering wheel center line.

8. A vehicle imaging system, comprising:
a first camera assembly configured to capture at least one first image of a vehicle first side area;
a second camera assembly configured to capture at least one rear image of a vehicle rear area;
a third camera assembly configured to capture at least one second image of a vehicle second side area, opposite the vehicle first side area;
a controller in communication with the first camera assembly and the second camera assembly and configured to
receive the first image and the rear image,
combine at least a portion of the first image and at least a portion of the rear image to generate a first side-rear image of the vehicle;
the controller in communication with the third camera assembly and further configured to
receive the second image and the rear image,
combine at least a portion of the second image and at least a portion of the rear image to generate a second side-rear image of the vehicle;
a first display arranged adjacent a driver viewing area and configured to display the first side-rear image; and
a second display arranged adjacent a passenger viewing area and configured to display the second side-rear image.

9. (canceled)

10. The system of claim 8, further comprising a vehicle communication bus configured to transmit data between the camera assemblies and the controller.

11. The system of claim 8, wherein the first and third camera assemblies are arranged at opposite sides of the vehicle.

12. The system of claim 11, wherein the first and third camera assemblies are arranged on separate and distinct winglets of the vehicle.

13. The system of claim 8, wherein the second camera assembly is arranged at a rear of the vehicle.

14. The system of claim 8, wherein the first display is arranged to the left of the steering wheel center line.

15. The system of claim 14, wherein the second display is arranged to the right of the steering wheel center line.

16. A vehicle imaging system, comprising:
a left camera assembly configured to capture at least one left image of a vehicle left side area;
a rear camera array configured to capture at least one rear image of a vehicle rear area;
a controller in communication with the left camera assembly and rear camera array and configured to
receive the left image and the rear image,
combine at least a portion of the left image and at least a portion of the rear image to generate a left-rear image of the vehicle; and
a left display arranged adjacent a driver viewing area and configured to display the left-rear image,
a right camera assembly configured to capture at least one right image of a vehicle right side area, the controller in communication with the right camera assembly and further configured to
receive the right image and the rear image,
combine at least a portion of the right image and at least a portion of the rear image to generate a right-rear image of the vehicle; and
a right display arranged adjacent a passenger viewing area and configured to display the right-rear image.

17. The system of claim 16, further comprising a vehicle communication bus configured to transmit data between the left camera assembly, rear camera array, and right camera assembly.

18. The system of claim 16, wherein the left and right camera assemblies are arranged on separate and distinct winglets of the vehicle.

19. The system of claim 16, wherein the left display is arranged to the left of the steering wheel center line and the right display is arranged to the right of the steering wheel center line.

20. The system of claim 16, wherein the controller is two independent controllers, one associated with the left camera assembly and one associated with the right camera assembly.
